(19) United States
(12) Patent Application Publication
(10) Pub. No.: US 2005/0213330 A1
(43) Pub. Date: Sep. 29, 2005

(54) Lamp for religious observances

(76) Inventor: Bryan Abish, Montreal (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/808,547

(22) Filed: Mar. 25, 2004

(51) Int. Cl. F21V 33/00

(52) U.S. Cl. 362/283

(57) ABSTRACT

There is described a lamp for selectively blocking out light, the lamp comprising: a lamp body having a socket at one end for receiving a light bulb and electrically powering the light bulb; a removable opaque covering dome to be placed on top of the light bulb for substantially blocking all light being generated by the light bulb; a lamp shade having mounting means for mounting the lamp shade to the socket, and an upper aperture allowing vertical access to the light bulb for placing the dome over the light bulb within the lamp shade; and a support platter positioned substantially around the socket for supporting the covering dome such that the covering dome is independent of the lamp and does not come into contact with the lamp body and the light bulb.

### CROSS-REFERENCE TO RELATED APPLICATIONS

This is the first application filed for the present invention.

### TECHNICAL FIELD

The present invention relates to common house lamps, and more specifically, to electric lamps which are usable in certain religious observances such as those used by observant Jews during Sabbath.

### BACKGROUND OF THE INVENTION

According to Halachah (traditional Jewish law), manipulating electricity during Sabbath is prohibited. Therefore, such activities as turning on or off a light switch is an infringement of Jewish law. In order to avoid these activities, it is common practice to either leave the lights on permanently during the periods of religious observance, or simply program timers that will automatically shut off the light at a predetermined time.

Several inconveniences can occur as a result of these limitations. For instance, if timers are set, it must be determined in advance what time the lights should be shut off at. Should there be a change of plan during the evening, it is not possible to reset the timers once Sabbath has started. As for leaving the light on all night, this is not a valid option in the bedroom, where darkness is eventually desired in order to sleep. In addition, intentionally touching a lamp during the Sabbath can constitute an infringement of the rules when they are followed in their strictest sense. In this case, one cannot pick up a lamp and move it into another room when the time comes to remove the light.

Some have attempted to cover lamps with dark clothing or opaque objects to prevent light from coming through without physically turning off the light. In addition to being a dangerous fire hazard, this practice is not an aesthetic one and may not completely block all light from being emitted from the lamp.

The prior art suggests various contraptions used to block light. For example, U.S. Pat. No. 4,809,145 to Bennett describes a free-standing and self-supporting lamp shade that could be placed over a lamp to block out the light, while leaving holes for the escape of heat. A shade base is provided to receive the shade. Using this device, light is not completely blocked, as can be seen in the figures. U.S. patent application 2003/0026099 to Dutka et al. describes an illumination device used to block out light for religious observance. While light is completely blocked using this device, the apparatus is complicated to make and is not compatible with standard lamps that may already be present in the home, nor can it be used as an ordinary house lamp.

Therefore, there is a need to provide an apparatus which will be aesthetically appealing and will allow one to selectively block out all light emitted from a lamp without requiring the kindling or extinguishing of electricity.

### SUMMARY OF THE INVENTION

It is an object of the present invention to overcome the drawbacks of the prior art by providing a simple design for a lamp that will allow a religious person to observe Jewish law during Shabbat.

It is also an object of the present invention to provide a device compatible with a standard lamp, that uses standard hardware, and can be adapted to a variety of existing lamp models already out on the market.

It is yet another object of the present invention to provide a device that can substitute a standard lamp.

In accordance with a first aspect of the present invention, there is provided a lamp for selectively blocking out light, the lamp comprising: a lamp body having a socket at one end for receiving a light bulb and electrically powering the light bulb; a removable opaque covering dome to be placed on top of the light bulb for substantially blocking all light being generated by the light bulb; a lamp shade having mounting means for mounting the lamp shade to the socket, and an upper aperture allowing vertical access to the light bulb for placing the dome over the light bulb within the lamp shade; and a support platter positioned substantially around the socket for supporting the covering dome such that the covering dome is independent of the lamp and does not come into contact with the lamp body and the light bulb.

In accordance with a second broad aspect of the present invention, there is provided a kit for use in combination with a lamp used to selectively block out light, the lamp having a lamp body with a socket at one end for receiving a light bulb and electrically powering the light bulb, the kit comprising: a lamp shade having mounting means for mounting the lamp shade to the socket, and an upper aperture allowing vertical access to the light bulb for placing a dome over the light bulb within the lamp shade; and a support platter positioned substantially around the socket for supporting the covering dome such that the covering dome is independent of the lamp and does not come into contact with the lamp body and the light bulb.

In accordance with a third broad aspect of the present invention, there is provided a kit for use in combination with a lamp used to selectively block out light, the lamp having a lamp body with a socket at one end for receiving a light bulb and electrically powering the light bulb, the kit comprising: a removable opaque covering dome to be placed on top of the light bulb for substantially blocking all light being generated by the light bulb; and a support platter positioned substantially around the socket for supporting the covering dome such that the covering dome is independent of the lamp and does not come into contact with the lamp body and the light bulb.

In accordance with a fourth broad aspect of the present invention, there is provided a lamp for selectively blocking out light, the lamp comprising: a lamp body having a lower base at a first end and a socket at a second end for receiving a light bulb and electrically powering the light bulb; a support platter directly connected to the socket, the support platter having a substantially centrally positioned aperture to mate with the socket; and a removable opaque covering dome to be placed over the light bulb and onto the support platter for substantially blocking light being generated by the light bulb.

Preferably, the lamp has a socket of the type which has a threaded ring used to secure a lamp shade with its own annular ring that is fitted around the socket. In this case, the support platter is placed between the ring of the lamp shade (its mounting means) and the threaded ring and no changes need to be made to the standard lamp. Alternatively, the socket may be of the type used with a harp or another clip adapter to connect lampshades of different styles to the socket. In this case, the harp or adaptor, which is usually attached to a lower part of the socket, can be cut and the platter can be secured (such as by welding) to the harp or adaptor. A lamp shade allowing the vertical access for the dome is can then be used with the lamp.

The lamp provided in accordance with the present invention has many advantages over the prior art. For example, a bulb that emits the equivalent of 100 Watts can be used because the heat dissipation within the dome is not a factor. The lamp can also provide 360° of light when the dome is not covering the light bulb. In addition, the lamp of the present invention has a cover that does not constitute an integral part of the lamp itself. It is considered a separate element to the lamp and therefore there is no need to come into contact with the lamp when using the present invention. The proposed lamp is simple and easy to use, while respecting all of the rules of the Jewish religion.

It should be understood that the various embodiments of the present invention can be used with standard lamp hardware and adapted to a variety of models. For example, all lamps with threaded ring and ring holder can be adapted to be used with the apparatus as described herein. As for the lamp shades, various adaptors allow lamps to accept shades of different styles. An adaptor that provides the upper aperture for allowing vertical access to the light bulb is compatible with the present invention.

### BRIEF DESCRIPTION OF THE DRAWINGS

Further features and advantages of the present invention will become apparent from the following detailed description, taken in combination with the appended drawings, in which:

FIGS. 1a-1f are front elevation views of the lamp components in accordance with a preferred embodiment of the present invention;

FIG. 2 is an exploded view of the lamp as assembled, in accordance with a preferred embodiment of the present invention;

FIG. 3 is a front elevation view of the assembled lamp with the components under the lamp shade shown in dotted lines, in accordance with a preferred embodiment of the present invention;

FIG. 4 is a front elevation view of the assembled lamp without the lamp shade and with the covering dome, in accordance with a preferred embodiment of the present invention;

FIG. 5 is a front elevation view of the assembled lamp without the covering dome and exposing the light bulb, in accordance with a preferred embodiment of the present invention;

FIG. 6 is a perspective view of the covering dome, in accordance with a preferred embodiment of the present invention;

FIG. 7 is a front elevation view of a covering dome with a door to selectively let the light through;

FIG. 8 is a front elevation view of a covering dome with an aperture to let light through;

FIG. 9 is a front elevation view of a pair of concentric rotatable covering domes to selectively let light through;

FIG. 10 is a front elevation view showing the lamp shade with the branches and mounting means attached to the top of the shade, in accordance with another embodiment of the present invention.

It will be noted that throughout the appended drawings, like features are identified by like reference numerals.

### DETAILED DESCRIPTION OF THE PREFERRED EMBODIMENT

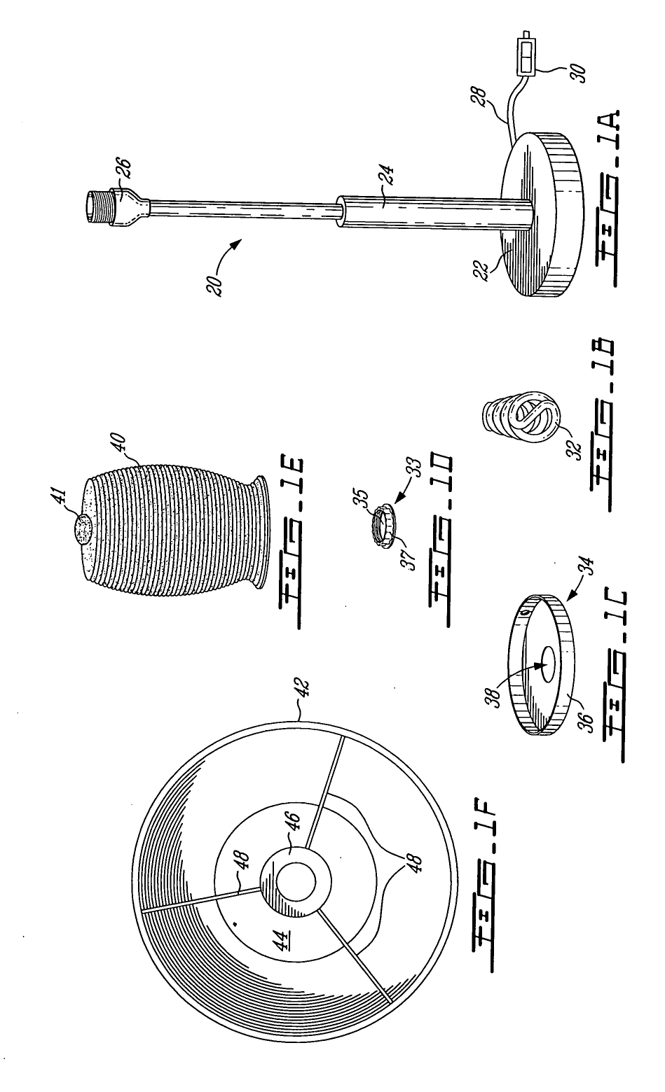

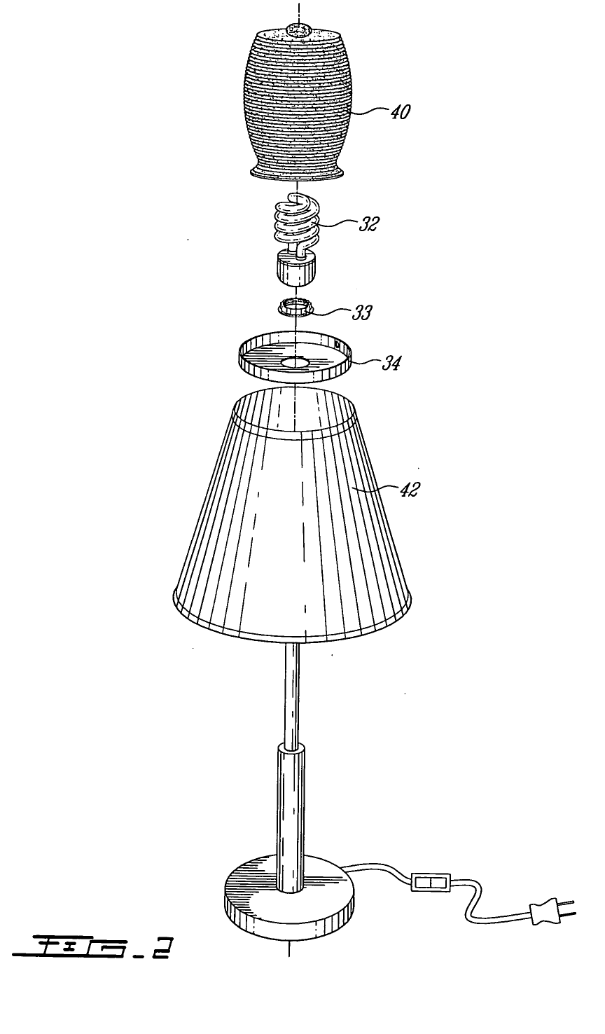

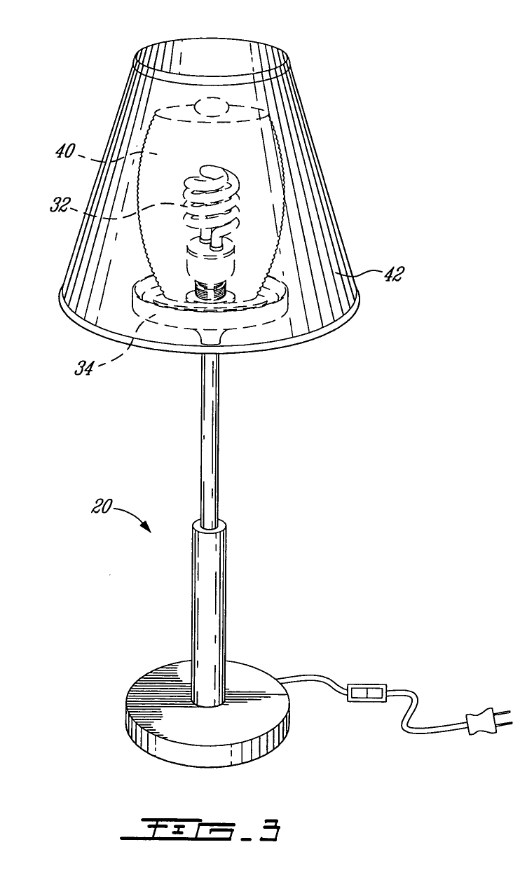

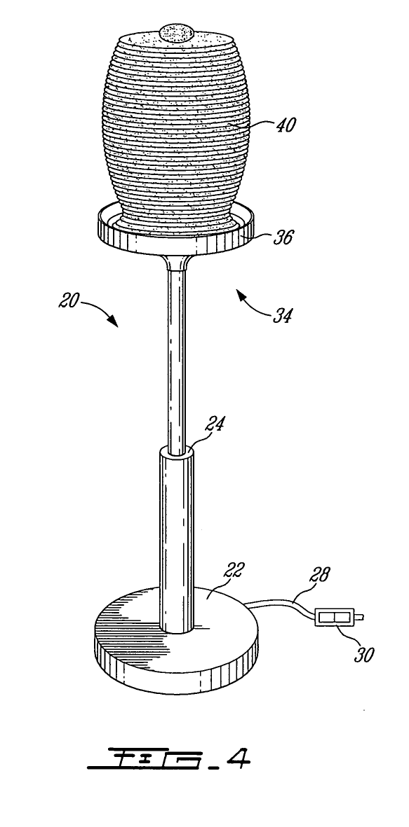

FIGS. 1a-1f show the lamp of the preferred embodiment in a disassembled state. FIG. 1a shows a lamp structure 20 that has a base 22, an elongated body 24, and a socket 26 at an upper end. An electrical cord 28 extends from the base 22. The electrical cord 28 is to be connected to a standard wall outlet to provide electricity to the lamp. Alternatively, the lamp may be battery operated and therefore be cordless. Electrically powering the light bulb should be understood as meaning through a wall outlet or a battery. A switch 30 to turn on the lamp can be present on the electrical cord 28 itself, as shown in the figure, or anywhere on the structure of the lamp (not shown). FIG. 1b is a light bulb 32, which is to be screwed into the socket 26 of the lamp structure 20. FIG. 1c shows a support platter 34 with a flange 36 around an outer perimeter and a circular aperture 38 positioned centrally. The circular aperture 38 is to be received by the socket 26 of the lamp structure 20. An annular securing ring 33 having an aperture 35 and threading 37 on its inner surface, as seen in FIG. 1d, is used to secure the support platter 34 to the socket 26 of the lamp structure 20. This hardware can be a standard threaded ring as found in common lamps, or a new piece of hardware provided especially for the present invention. FIG. 1e shows a covering dome 40. The dome 40 has a hollow interior and a circular base. A handle 41 is used to manipulate the dome 40. A lamp shade 42 is shown in FIG. 1f. The lamp shade 42 has an aperture 44 at an upper end thereof for allowing vertical access from the top. Mounting means, such as the attachment ring 46 and the three branches that connect the ring 46 to the base of the shade 42 are used to mount the lamp shade 42 to the lamp structure 20. The ring 46 is to be received by the socket 26 of the lamp structure 20. The lamp shade may be removably mounted to the lamp structure, or permanently mounted, such as by welding.

As per FIG. 2, the various components of the lamp seen in FIG. 1 are assembled together to form the lamp. The lamp shade 42 is first placed on the socket 26. The socket has a narrow upper portion with a smaller diameter than the attachment ring 46, and a wider lower portion on which the attachment ring 46 rests. From the top opening 44 of the lamp shade 42, the support platter 34 is placed onto the socket 26. The securing ring 33 is then placed on top of the support platter 34 and threadingly engages with the socket 26 via its inner threading 37. The securing ring 33 stabilizes the support platter 34 such that it can support the covering dome 40. The light bulb 32 is then screwed into the socket 26 of the lamp structure 20. At this point, the lamp is capable of emitting light when turned on. To block the light while the electricity still powers the light bulb 32, the covering dome 40 is inserted by the opening 44 of the lamp shade 42 and placed over the light bulb 32 onto the support platter 34. (or any other assembly order).

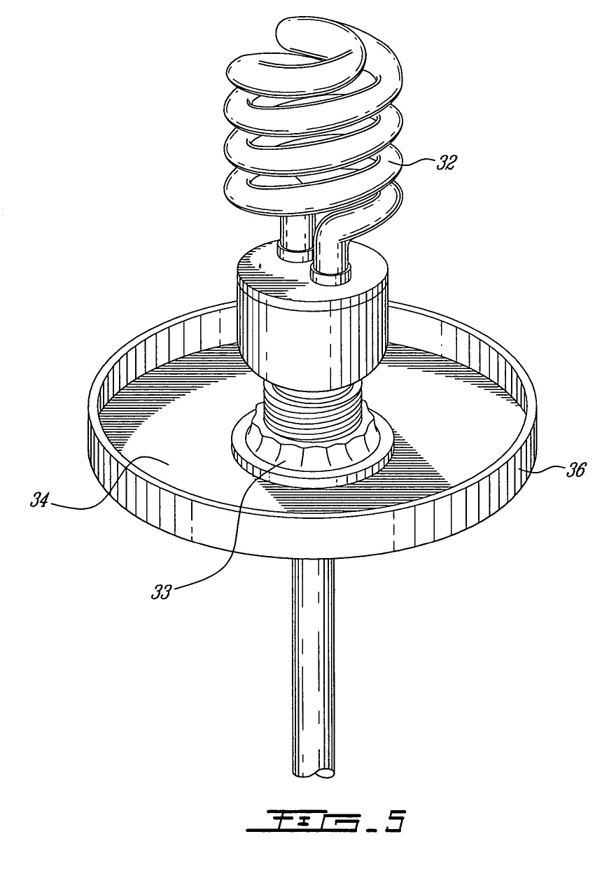

FIG. 3 shows the lamp in a fully assembled state, with the components under the lamp shade 42 shown in dotted lines. The dome 40 sits on the platter 34 and covers the bulb 32.

FIG. 4 is a view of the preferred embodiment of the lamp without the lamp shade 42. A support platter 34 is positioned at socket level of the lamp body 24. The support platter 34 is a flat surface that receives and supports the covering dome 40. The flange 36 is used to secure the dome 40 on the support platter 34 and prevent it from falling off. Additionally, it helps to direct the user as the dome 40 is deposited onto the platter 34.

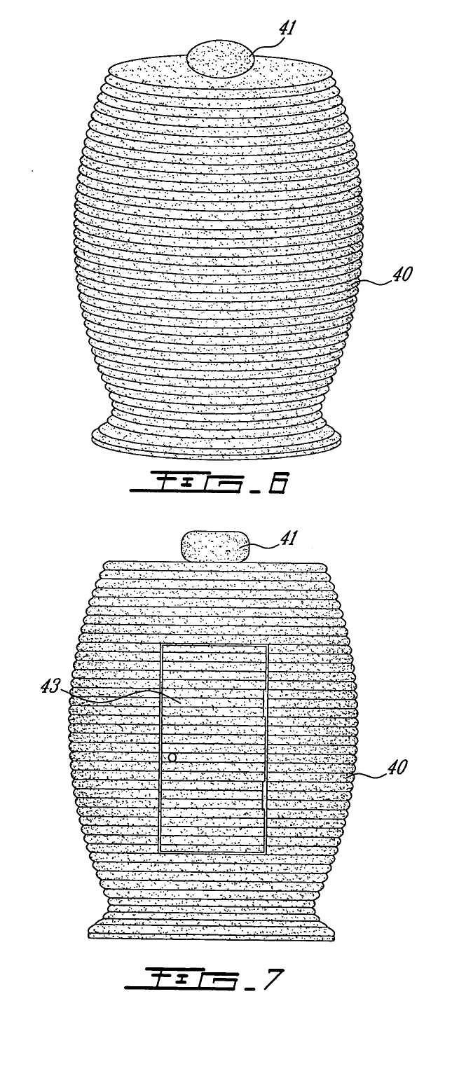

FIG. 5 is an enlarged view of the support platter 34 and light bulb 32 assembled to the socket 26 of the lamp. In a preferred embodiment, the light bulb 32 is an energy saving compact fluorescent light bulb for longer life and energy savings. It can be appreciated that any type of light bulb having a base that can mate with the socket of the lamp can be used and that has a similar form factor. The bulbs used can be incandescent, fluorescent, halogen, etc. They can be of the type with the ballast built into the base, or the two-piece type in which the ballast is connected to an adaptor, the adaptor connecting into the light socket. In addition, a light bulb and platter can be integrated into one piece of hardware by having a bulb with an outwardly extending base that is capable of receiving the dome without requiring an additional platter.

FIG. 6 is a perspective view of the covering dome 40 in accordance with a preferred embodiment of the present invention. The dome 40 is preferably made of ceramic, but can be made of any type of non-melting material, such as metal, plastic, Teflon, etc. The dome 40 defines a hollow interior which completely covers the light bulb 32 and the base seals against the support platter 34 to prevent light from escaping. A handle 41 is used to manipulate the dome 40. Other embodiments for the handle, such as a hoop or a projecting member, are also possible. It should be noted that the handle is insulated from the rest of the dome and therefore, remains cooler. The handle allows the user to manipulate the dome without getting burned.

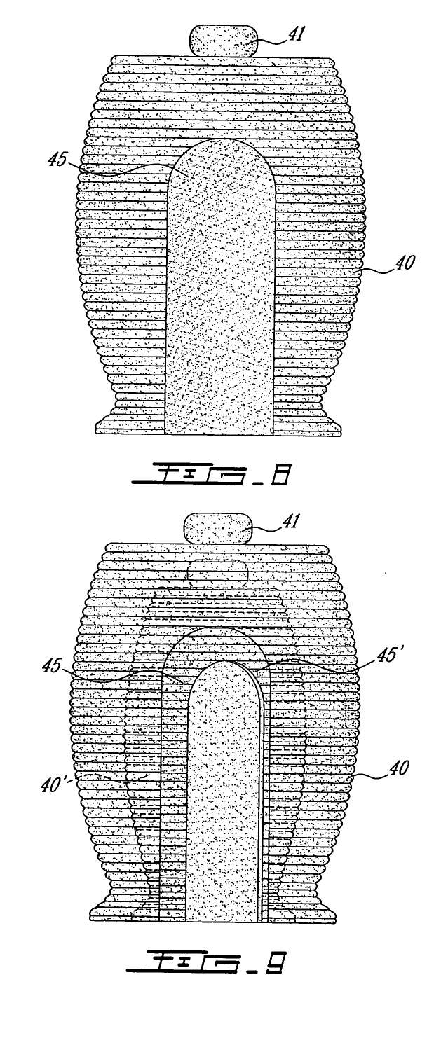

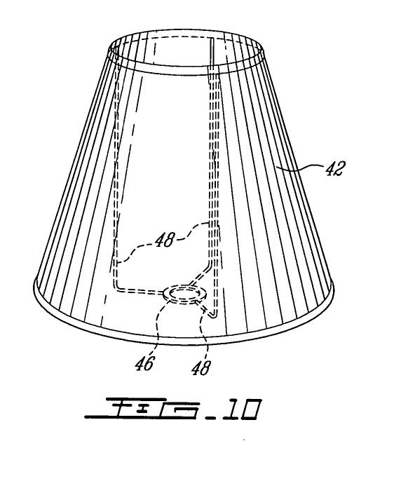

Various embodiments are possible for the dome 40. The covering dome 40 can be designed with an aperture on a vertical surface thereof and means for closing the aperture for selectively allowing light through the opening. In FIG. 7, the means for closing the aperture is a door 43. This door can be sliding or hinged and operable using a small handle. In FIG. 8, no door is provided directly on the dome 40. The aperture 45 is on a side of the dome 40 and can be covered using a second dome of larger diameter than the first dome. For example, the dome of FIG. 6 with no aperture, can be placed on top of the dome of FIG. 8, provided the dome of FIG. 6 is of a larger diameter than that of FIG. 8. Alternatively, the second dome may also have an aperture on a surface thereof. FIG. 9 displays two such domes (40 and 40′) one on top of the other. When the two domes (40 and 40′) are positioned such that the two apertures (45 and 45′) are aligned, light is projected therethrough. When the two domes (40 and 40′) are positioned such that the two apertures (45 and 45′) are not aligned, light is sealed within the covering structure. The dome can be of any shape that can properly cover the light bulb 32.

Various embodiments are also possible for the support platter 34. While the support platter 34 is circular in the preferred embodiment, different shapes are possible as long as the covering dome 40 is properly supported. For example, a square or hexagonal plate would also serve the function, which is to support the covering dome. The support platter 34 may be formed with a threading around an inner surface of the aperture 38 such that it can be threaded onto the socket. In this case, the securing ring 33 is no longer necessary to stabilize the platter 34. The support platter 34 may have a recess along its surface such that the base of the covering dome fits into the recess and is thereby secured in place (not shown).

While the lamp shade 42 has been illustrated as an upside-down cone throughout the figures, it should be understood that various shapes are possible. For example, a right-side-up cone or cylindrical shaped lamp shade allowing vertical access to the bulb through the top is also consistent with the present invention. The branches 48, of which there can be any number greater than two, can be attached to the top of the lamp shade, provided that they afford sufficient room to insert the covering dome via the top of the lamp shade, as shown in FIG. 10.

As stated above, the present invention may be adapted to standard lamps. One embodiment of the present invention consists in a kit comprising a lamp shade and a support platter. The kit could additionally have a light bulb included, the light bulb being a special fluorescent light bulb that emits less heat than a standard incandescent light bulb, but still fits within the socket of a standard lamp. Therefore, a lamp having a different type of shade can be adapted by simply replacing the shade such that it allows the vertical dome to be inserted from the top, and the platter is inserted to receive the dome. The dome may be separate from the kit, or included in it.

In accordance with another embodiment of the present invention, a kit may consist of the dome and the platter. Since some lamps are already equipped with the lamp shades having the vertical access from the top, all that would be needed to adapt a standard lamp to the present invention is the dome and the platter to support the dome. Additionally, a light bulb may also be included in this kit. lamp shade that is completely opaque, sealed on the top and bottom, with a door on it.

It should be understood that the present invention may be applicable to table lamps, floor lamps, wall lamps (such as swing-arms), etc. The embodiments of the invention described above are intended to be exemplary only. The scope of the invention is therefore intended to be limited solely by the scope of the appended claims.

1. A lamp for selectively blocking out light, the lamp comprising:
a lamp body having a lower base at a first end and a socket at a second end for receiving a light bulb and electrically powering said light bulb;
a removable opaque covering dome to be placed over said light bulb for substantially blocking light being generated by said light bulb;
a lamp shade having mounting means for mounting said lamp shade at a level of said socket, and an upper aperture allowing vertical access to said light bulb for placing said dome over said light bulb within said lamp shade; and
a support platter positioned substantially at said level of said socket for supporting said covering dome such that said covering dome is independent of said lamp and does not come into contact with said lamp body and said light bulb.

2. A lamp as claimed in claim 1, wherein said support platter comprises a centrally positioned aperture to mate with said socket.

3. A lamp as claimed in claim 2, wherein said aperture is circular and said support platter integrates a threaded ring to engage with said socket.

4. A lamp as claimed in claim 2, further comprising an annular ring to threadingly engage said socket to secure said support platter to said lamp body.

5. A lamp as claimed in claim 2, wherein said support platter is circular.

6. A lamp as claimed in claim 2, wherein said support platter has a flange around an outer perimeter to facilitate placement of said covering dome.

7. A lamp as claimed in claim 1, wherein said mounting means comprise three branches attached to a ring for receiving said socket.

8. A lamp as claimed in claim 1, wherein said covering dome is made of ceramic.

9. A lamp as claimed in claim 1, wherein said covering dome comprises a handle positioned on an upper surface thereof to manipulate said covering dome.

10. A lamp as claimed in claim 1, wherein said covering dome comprises an aperture on a vertical surface thereof and means for closing said aperture for selectively allowing light through said opening.

11. A lamp as claimed in claim 10, wherein said means for closing said aperture comprise a sliding door.

12. A lamp as claimed in claim 10, wherein said means for closing said aperture comprise a second dome having a larger diameter than said covering dome such that said covering dome may be disposed within said second dome.

13. A lamp as claimed in claim 12, wherein said second dome comprises an aperture on a vertical surface thereof, such that alignment of apertures of said covering dome and said second dome allow light therethrough and misalignment prevents light from escaping.

14. A lamp as claimed in claim 1, further comprising a fluorescent light bulb having a form factor of a standard incandescent light bulb.

15. A kit for use in combination with a lamp used to selectively block out light, the lamp having a lamp body with a socket at one end for receiving a light bulb and electrically powering said light bulb, the kit comprising:
a lamp shade having mounting means for mounting said lamp shade to said socket, and an upper aperture allowing vertical access to said light bulb for placing a dome over said light bulb within said lamp shade; and
a support platter positioned substantially around said socket for supporting said covering dome such that said covering dome is independent of said lamp and does not come into contact with said lamp body and said light bulb.

16. A kit as claimed in claim 15, wherein said lamp shade and support platter are formed as one piece.

17. A kit as claimed in claim 15, wherein said support platter comprises a centrally positioned aperture to mate with said socket.

18. A kit as claimed in claim 17, wherein said aperture is circular and said support platter integrates a threaded ring to engage with said socket.

19. A kit as claimed in claim 17, further comprising an annular ring to threadingly engage said socket to secure said support platter to said lamp body.

20. A kit as claimed in claim 17, wherein said support platter is circular.

21. A kit as claimed in claim 17, wherein said support platter has a flange around an outer perimeter to facilitate placement of said covering dome.

22. A kit as claimed in claim 15, wherein said mounting means comprise three branches attached to a ring for receiving said socket.

23. A kit as claimed in claim 15, further comprising a removable opaque covering dome to be placed on top of said light bulb for substantially blocking all light being generated by said light bulb, wherein said dome is supported by said support platter.

24. A kit as claimed in claim 23, wherein said covering dome is made of ceramic.

25. A kit as claimed in claim 23, wherein said covering dome comprises an aperture on a vertical surface thereof and means for closing said aperture for selectively allowing light through said opening.

26. A kit as claimed in claim 25, wherein said means for closing said aperture comprise a sliding door.

27. A kit as claimed in claim 25, wherein said means for closing said aperture comprise a second dome having a larger diameter than said covering dome such that said covering dome may be disposed within said second dome.

28. A kit as claimed in claim 27, wherein said second dome comprises an aperture on a vertical surface thereof, such that alignment of apertures of said covering dome and said second dome allow light therethrough and misalignment prevents light from escaping.

29. A kit as claimed in claim 15, further comprising a fluorescent light bulb having a form factor of a standard incandescent light bulb.

30. A kit for use in combination with a lamp used to selectively block out light, the lamp having a lamp body with a socket at one end for receiving a light bulb and electrically powering said light bulb, the kit comprising:
a removable opaque covering dome to be placed on top of said light bulb for substantially blocking all light being generated by said light bulb; and
a support platter positioned substantially around said socket for supporting said covering dome such that said covering dome is independent of said lamp and does not come into contact with said lamp body and said light bulb.

31. A kit as claimed in claim 30, wherein said support platter comprises a centrally positioned aperture to mate with said socket.

32. A kit as claimed in claim 31, wherein said support platter threadingly engages with said socket via said aperture.

33. A kit as claimed in claim 31, further comprising an annular ring to threadingly engage said socket to secure said support platter to said lamp body.

34. A kit as claimed in claim 31, wherein said support platter is circular.

35. A kit as claimed in claim 31, wherein said support platter has a flange around an outer perimeter to facilitate placement of said covering dome.

36. A kit as claimed in claim 30, wherein said covering dome is made of ceramic.

37. A kit as claimed in claim 30, wherein said covering dome comprises a handle positioned on an upper surface thereof to manipulate said covering dome.

38. A kit as claimed in claim 30, wherein said covering dome comprises an aperture on a vertical surface thereof and means for closing said aperture for selectively allowing light through said opening.

39. A kit as claimed in claim 30, wherein said means for closing said aperture comprise a sliding door.

40. A kit as claimed in claim 38, wherein said means for closing said aperture comprise a second dome having a larger diameter than said covering dome such that said covering dome may be disposed within said second dome.

41. A kit as claimed in claim 40, wherein said second dome comprises an aperture on a vertical surface thereof, such that alignment of apertures of said covering dome and said second dome allow light therethrough and misalignment prevents light from escaping.

42. A kit as claimed in claim 30, further comprising a fluorescent light bulb having a form factor of a standard incandescent light bulb.

43. A lamp for selectively blocking out light, the lamp comprising:
a lamp body having a lower base at a first end and a socket at a second end for receiving a light bulb and electrically powering said light bulb;
a support platter directly connected to said socket, said support platter having a substantially centrally positioned aperture to mate with said socket; and
a removable opaque covering dome to be placed over said light bulb and onto said support platter for substantially blocking light being generated by said light bulb.

44. A lamp as claimed in claim 43, wherein said aperture is circular and said support platter integrates a threaded ring to engage with said socket.

45. A lamp as claimed in claim 43, further comprising an annular ring to threadingly engage said socket to secure said support platter to said lamp body.

46. A lamp as claimed in claim 43, wherein said support platter is welded to said socket.

47. A lamp as claimed in claim 43, wherein said support platter is circular.

48. A lamp as claimed in claim 43, wherein said support platter has a flange around an outer perimeter to facilitate placement of said covering dome.

49. A lamp as claimed in claim 43, further comprising a lamp shade having mounting means for mounting said lamp shade to said socket, and an upper aperture allowing vertical access to said light bulb for placing said dome over said light bulb within said lamp shade.

50. A lamp as claimed in claim 49, wherein said mounting means comprise three branches attached to a ring for receiving said socket.

51. A lamp as claimed in claim 43, wherein said covering dome is made of ceramic.

52. A lamp as claimed in claim 43, wherein said covering dome comprises a handle positioned on an upper surface thereof to manipulate said covering dome.

53. A lamp as claimed in claim 43, wherein said covering dome comprises an aperture on a vertical surface thereof and means for closing said aperture for selectively allowing light through said opening.

54. A lamp as claimed in claim 53, wherein said means for closing said aperture comprise a sliding door.

55. A lamp as claimed in claim 53, wherein said means for closing said aperture comprise a second dome having a larger diameter than said covering dome such that said covering dome may be disposed within said second dome.

56. A lamp as claimed in claim 55, wherein said second dome comprises an aperture on a vertical surface thereof, such that alignment of apertures of said covering dome and said second dome allow light therethrough and misalignment prevents light from escaping.

57. A lamp as claimed in claim 43, further comprising a fluorescent light bulb having a form factor of a standard incandescent light bulb.
